(19) United States
(12) Patent Application Publication
(10) Pub. No.: US 2009/0153338 A1
(43) Pub. Date: Jun. 18, 2009

(54) Power Alert System

(76) Inventor: Mark Komosa, Lisle, IL (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 11/958,543

(22) Filed: Dec. 18, 2007

(51) Int. Cl. G08B 21/18

(52) U.S. Cl. 340/635

(57) ABSTRACT

Disclosed is a power alert system installed at a consumer premises. The power alert system comprises a power status transmitter, which is installed at the consumer premises. The power status transmitter is configured to notify a status of power supply to a handheld device of the consumer. The power status transmitter notifies to the handheld device of the consumer the status of the power supply by one of an email communication and a text message communication.

### FIELD OF THE INVENTION

The present invention relates generally to public utility status alert devices, and more particularly, to power alert systems for notifying consumers about the power status at their premises.

### BACKGROUND OF THE INVENTION

In contemporary technology-dependent society, every household is equipped with a variety of electrical and electronic appliances. A majority of these appliances are power-supply driven appliances. Some of these appliances in a home or in commercial setups require uninterrupted power supply. An intermittent power cut may affect the safety of a number of things in the premises, such as pets, kids, foods and beverages.

Further, some small business setups including, but not limited to, meat freezing industries and ice factories, require a continuous power supply. Hence, consumers generally will intend to keep a track of the status of power supply at their homes or business setups so that they may take any further necessary steps as an alternative to resume the power supply. The existing techniques that notify the consumers about the power status in a particular location are ordinarily through television or announcement by radio. In general, it is often probable that consumers may miss these announcements over television or radio about the status of the power supply in their location.

Therefore, based on the foregoing, there is a need for a power alert system that keeps tracking the status of power supply of the consumer's premises and capable of notifying the consumer of any update in the status of the power supply.

### SUMMARY OF THE INVENTION

In view of the foregoing disadvantages inherent in the prior art, the general purpose of the present invention is to provide a power alert system configured to include all the advantages of the prior art, and to overcome the drawbacks inherent therein.

Therefore, an object of the present invention is to provide a power alert system that is capable of tracking a status of power supply at consumers' premises.

It is another object of the present invention to provide a notification of the status of the power supply at the consumer premises to the consumers.

In light of the above objects, in one aspect, the present invention provides a power alert system. The power alert system comprises a power status transmitter installed in a consumer premises. The power status transmitter is configured to notify the consumer of a status of a power supply at the consumer premises. The power status transmitter notifies the consumer by way of one of an email communication and a Short Message Service (SMS).

These together with other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a block diagram of a power alert system, according to an exemplary embodiment of the present invention; and

FIG. 2 is a schematic diagram illustrating an application of the power alert system, according to an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a power alert system, as shown and described. It is understood that various omissions and substitutions of equivalents are contemplated as circumstances may suggest or render expedient, but these are intended to cover the application or implementation without departing from the spirit or scope of the claims of the present invention.

The terms “a” and “an” herein do not denote a limitation of quantity, but rather denote the presence of at least one of the referenced item.

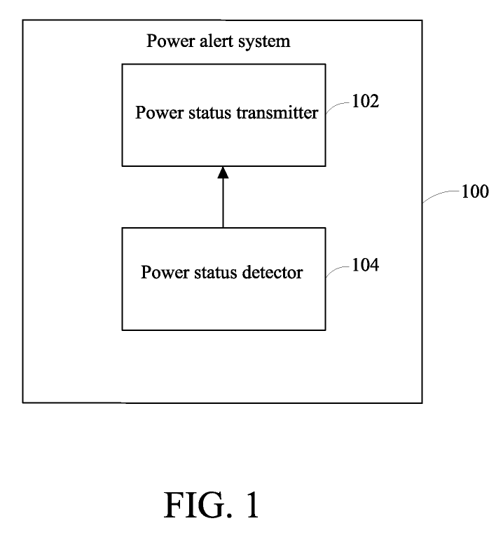

Referring to FIG. 1, a block diagram of a power alert system 100 is shown, according to an exemplary embodiment of the present invention. The power alert system 100 may be fitted at a consumer premises. For the purpose of this description, the consumer premises refer to a home of the consumer or a business facility of the consumer. The power alert system 100 comprises a power status transmitter 102, which may be plugged in at any point of an electrical line distribution in the consumer premises, for example, at a Main Circuit Board (MCB) or fuse box. Alternatively, the transmitter 102 may be plugged directly into standard electrical outlet on the premises. The power alert system 100 also comprises a power status detector 104, which may be any Light Emitting Diode (LED) or a simple electronic switch known in the art. The power status detector 104 may be a sub-component of the power status transmitter 102. In another embodiment of the present invention, the power status detector 104 may also be a separate component to the power status transmitter 102.

The power status detector 104 detects any change in the status of the power supply within the premises. For example, the power status detector 104 detects whether the power supply is in an ON status or in an OFF status. Herein, the ON status of the power supply represents availability of the power supply and the OFF status of the power supply represents unavailability of the power supply. The power status detector 104 provides information of any change in the status of the power supply to the power status transmitter 102. For example, when power supply is cut, i.e., in OFF status, the power status detector 104 informs the power status transmitter 102 about the power cut. Further, the power status detector 104 re-informs the power status transmitter 102, when the power supply is resumed to the ON status. Furthermore, the power status transmitter 102 keeps notifying the status of the power supply and of changes in such status to a handheld device of the consumer.

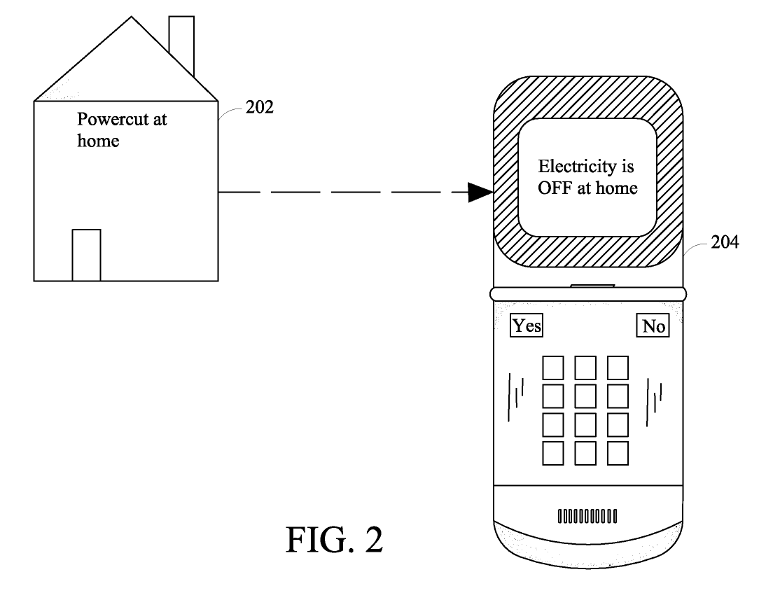

Referring now to FIG. 2, a schematic diagram illustrating an application of the power alert system 100 is shown, according to an exemplary embodiment of the present invention. FIG. 2 represents a schematic representation of an application of the power alert system 100 in a home 202 of the consumer. The power alert system 100 (not shown in FIG. 2) is installed in the home 202 of the consumer for notifying the status of the power supply to the consumer at his handheld device, such as a cell phone 204. In this exemplary representation, it is shown that the power supply is not available at the home 202 of the consumer. The power alert system 100 notifies at the cell phone 204 by a text message displayed as ‘Electricity is OFF at home’, at a screen of the cell phone 204.

The representation of the application of the power alert system 100 in FIG. 2 is for exemplary purposes only. The power alert system 100 may also notify to the other wireless handheld devices such as portable computers and personal digital assistant (PDA). Further, the power alert system 100 may also send the email notification for providing the information of the status of power supply.

The power alert system 100 may be installed at any business setup, such as cold storage houses and meat freezers, where a continuous power supply is required. Hence, using the power alert system 100 in these business setups may help business owners to take necessary steps in case of non-availability of power supply within the premises or based on the time duration of the non-availability of the power supply.

In another embodiment of the present invention, the power alert system 100 may be used on in connection with a plurality of consumers, such that the system is operatively coupled to a power grid. In this embodiment, the power alert system 100 may simultaneously notify all the consumers that receive power from a particular power grid about the status of the power supply on that grid.

In another embodiment of the present invention, the power alert system 100 may be installed in the home 202 of one person and may be configured to notify the cell phone 204 of another person. In this embodiment, the system 100 permits a nurse, for example, to receive notification on his or her cell phone 204 of an interruption in power at the home 202 of an elderly or infirm patient such that the nurse can act accordingly to provide care for the elderly patient.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. A power alert system comprising:
a power status transmitter installed at a consumer premises, the power status transmitter configured to notify a status of power supply at the consumer premises to a handheld device of the consumer, wherein the power status transmitter notifies to the handheld device by one of an email communication and a Short Message Service (SMS).

2. The power alert system of claim 1, wherein the power alert system comprises a power status detector for detecting the status of the power supply.

3. The power alert system of claim 1, wherein the handheld device is a wireless handheld device.

4. A power alert system comprising:
a power status transmitter installed at a premises, the power status transmitter configured to notify a status of power supply at the premises to a handheld device of a consumer, wherein the power status transmitter notifies to the handheld device by one of an email communication and a Short Message Service (SMS).
